(19) United States
(12) Patent Application Publication
(10) Pub. No.: US 2023/0255362 A1
(43) Pub. Date: Aug. 17, 2023

(54) HEIGHT ADJUSTABLE BABY CRIB ARRANGED WITH A BLOCKABLE CRADLE FUNCTION

(71) Applicant: Cecilia LARSSON, GÖTEBORG (SE)

(72) Inventor: Cecilia LARSSON, GÖTEBORG (SE)

(21) Appl. No.: 18/005,073

(22) PCT Filed: Jul. 2, 2021
(86) PCT No.: PCT/SE2021/050675

§ 371 Date: Jan. 11, 2023

(30) Foreign Application Priority Data
Jul. 15, 2020 (SE) 2000122-8

(51) Int. Cl. A47D 7/02; A47D 9/04

(52) U.S. Cl. CPC A47D 7/02; A47D 9/04

(57) ABSTRACT

The present invention relates to a height adjustable baby crib (2) comprising a tube stand (13) with a suspension device (8) for rockable suspension of the baby crib (2), bed bottom (4), head boards (9), bed sides (4), and an arrangement for mechanical height adjusting of the baby crib (2) in the tube stand (13) with the aid of telescopic pair-controlled gas springs (5,7) that can be exercised by a foot pedal (6). The baby crib (2) is so constructed that it could also be used as a cradle.

### TECHNICAL AREA

The present invention relates to a height adjustable baby crib and more specific a height adjustable baby crib comprising a tube stand in which the baby crib is suspended and where the baby crib with a simple manipulation could also be used as a cradle as dedicated locks between the tube stand and the baby crib are loosened.

### Problem

A woman who has recently become a mother has many times experienced problems with her back already during her pregnancy. During several years somebody must then manage to lift the baby in and out of the crib. In case of many cradles or baby cribs of today the user must bend down in the crib in an uncomfortable and sometimes painful position to lay down or lift the baby. Many parents spend several hours in this uncomfortable position during night and day when the baby should for instance go to sleep. This work could often cause future or immediate problems with the back.

### Technical Field

Height adjustable baby cribs could be found in multiple models.

GB 2485676 describes a conventional mechanical lifting device of scissor type that could be placed under a bed bottom.

IT 1238733 describes a conventional mechanical lifting device of scissor type to be placed under a bed bottom and that is equipped with gas springs and mechanical springs.

U.S. Pat. No. 2,968,817 describes a lifting device of scissor type with balance springs.

US 2007180620 describes a motorised lifting device for beds and that is operated by grid powered electric motors.

US 20090070929 describes a motorised lifting device for beds and that is operated by battery powered electric motors.

US 2012/0186375 describes a motor operated lifting device of scissor type for beds.

Lifting devices of scissor type will require a relatively large amount of space under the bed, and they also have many moving parts, which will easily collect dust and take time to keep clean. There is also a wish from the person who should lift or lay the baby down in the crib to get close to this. A lifting device of scissor type could easily be in the way for the legs, and the lifting process will thus be too uncomfortable. The open moving parts of a lifting device of scissor type also constitute a pinch risk for the user and for small children, who possibly are staying close to the bed.

There is also a wish not to have grid operated motors in connection to lifting devices for baby cribs, as wires to these as well as the motors as such could constitute a safety risk.

Most baby cribs described in earlier documents have lifting devices of scissor type, and none of them have any function that makes it possible to use the baby crib (2) as a cradle.

### DESCRIPTION OF THE INVENTION

The invention solves the problems described above by providing a height adjustable baby crib (2) comprising a tube stand (13) with a suspension device (8) for rockable suspension of the baby crib (2), bed bottom (10), head boards (9), bed sides (4) and a device for mechanical height adjustment of the baby crib (2) in the tube stand (13). The height adjustment is accomplished by telescopic pair-controlled gas springs (5,7) that are exercised by for instance a foot pedal (6) when the baby crib (2) should be raised. When the baby crib (2) later should be lowered, the gas springs (5,7) are released by the foot pedal (6), and the baby crib (2) could then with low force be pressed downwards to desired height and stay there, when the foot pedal (6) is released. As an alternative to the foot pedal (6), a hand lever could be used (not shown).

The telescopic pair-controlled gas springs could be built into the vertical parts (1) of the of the tube stand (13) to eliminate the pinch risk.

The baby crib (2) could further be equipped with a function that one or both bed sides (4) could be individually adjusted in height and locked into different positions.

The baby crib (2) is further equipped with a function that the baby crib (2) could be used as a cradle, when a locking device (not shown) on the baby crib (2) could be partly released from the tube stand (13). The locking device could be a conventional slider bolt and is preferably placed in the lower part of the baby crib (2).

From safety reasons the bed sides (4) must be locked in their top positions, when the baby crib (2) is to be used as cradle. Of this purpose a safety lock (11,12) is installed in the lower part of the vertical part (1) of the tube stand (13).

### FIGURES

FIG. 1 shows a perspective view of the invention with the baby crab in a lowered position.

FIG. 2 shows a perspective view of the invention with one bed side in lowered position.

FIG. 3 shows perspective view of the invention with the baby crab in raised position.

FIG. 4 shows i side view of the invention with the baby crab in lowered position.

FIG. 5 shows i side view of the invention with the baby crab in raised position.

FIG. 6. shows a perspective view of the invention with one bed side in lowered position and the safety lock for the cradle visible.

FIG. 7 shows a gable view of the invention with one bed side in lowered position and the safety lock for the cradle visible.

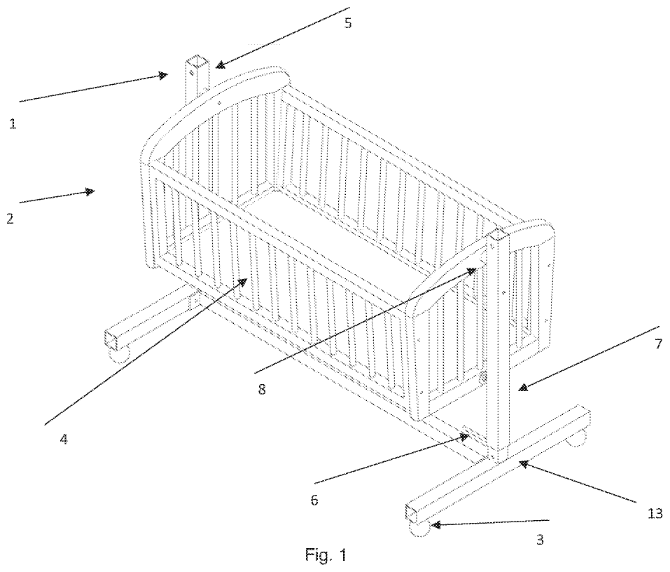

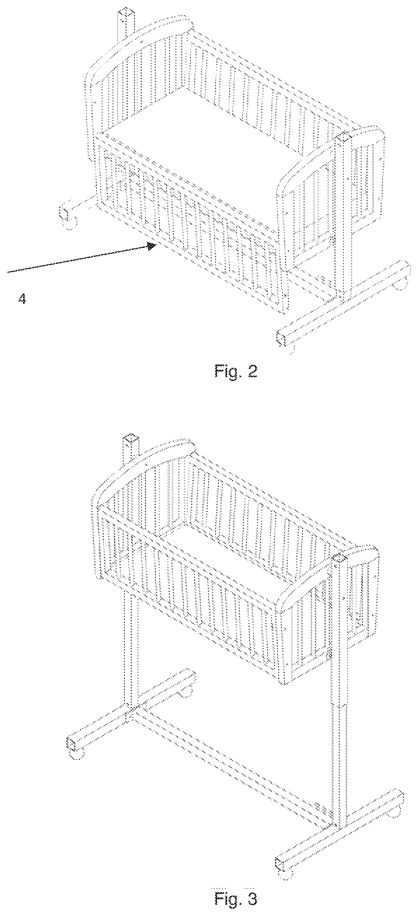

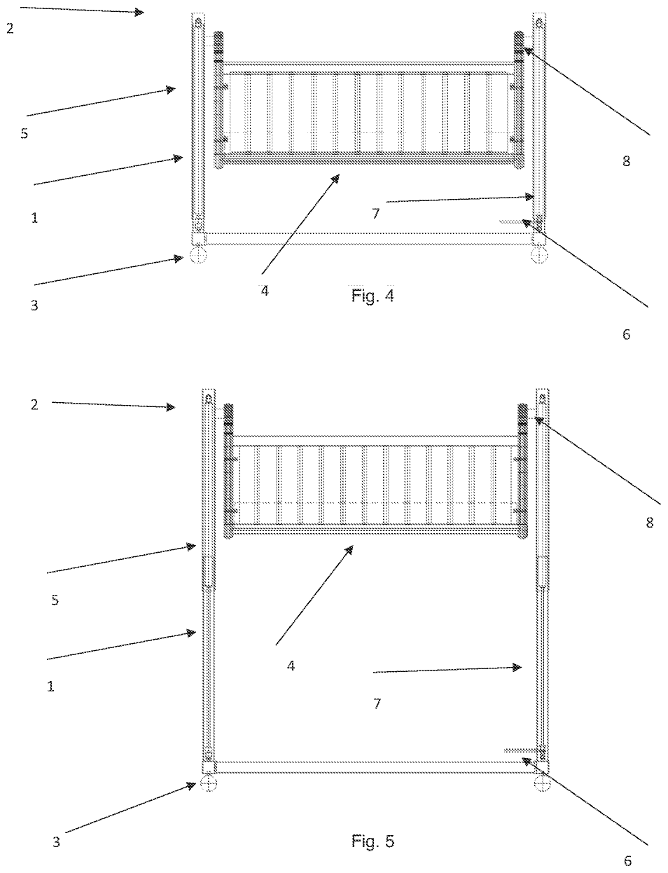

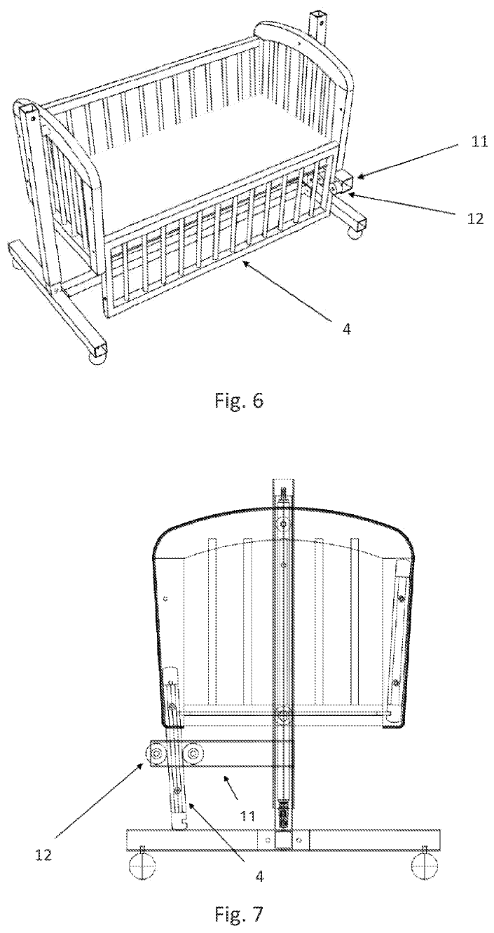

### EXAMPLES

The invention constitutes a height adjustable baby crib (2) comprising a tube stand (13) with a suspension device (8) for rockable suspension of the baby crib (2) in the tube stand (13), a bed bottom (10), head boards (9), bed sides (4) and telescopic pair-controlled gas springs (5,7) in the tube stand (13) of which at least one is lockable (5), and that are exercised by a foot pedal (6) when the baby crib (2) should be raised. When the baby crib (2) later should be lowered, the gas springs (5,7) are released by the foot pedal (6), and the baby crib (2) could then with low force be pressed downwards to desired height and stay there, when the foot pedal (6) is released. The gas springs (5,7) are calibrated in such a way that only a minor force is needed to raise or lower the baby crib (2) in the tube stand (13).

The tube stand (13) could be made from square tubes, why the gas springs (5,7) could be located inside the vertical parts (1) to eliminate the pinch risk.

The two bed sides (4) of the baby crib (2) are individually height adjustable and equipped with blocks, so they could be locked in low and top and in at least one more position. The blocks could be conventional sliding bolts. The bed sides (4) are further equipped with bear rings to facilitate raising and lowering.

The baby crib (2) could be used as a cradle, as it is equipped with a cradle lock (not shown), that could partly release the baby crib (2) from the tube stand (13). The cradle lock could be for instance a conventional sliding bolt, and is preferably located in the lower region of the baby crib (2)

From safety reasons the bed sides (4) must be blocked in the top position, when the baby crib (2) should be used as a cradle. This function is achieved that the tube stand (13) is equipped with a blocking equipment in the form of a cross-stroke (11) that in its other end is equipped with two longitudinal horizontal rollers (2) through which the bed side (4) could run up and down. When the bed side (4) runs through the rollers (12) the bed side (4) locks the baby crib (2) so that it cannot be rocked. When the bed side (4) is in its top position, this is loosened from the rollers (12), and the baby crib (2) could be rocked. If the bed side (4) on the opposite side of the baby crib (2) also could run up and down, a corresponding blocking equipment is placed also there.

The tube stand (13) could be equipped with swirling wheels (3) to facilitate moving of the baby crib (2) over the floor. The wheels (3) could also be lockable to make the baby crib (2) be steadily positioned on the floor.

The description shows an embodiment, but the invention is not limited by this within the scope of the following patent claims.

1. Height adjustable baby crib (2) comprising a tube stand (13) for rockable suspension of the baby crib (2), bed bottom (10), head boards (9), bed sides (4) and a device for mechanical height adjustment of the baby crib (2) in the tube stand (13) by telescopic pair-controlled gas springs (5,7) that are exercised by a foot pedal (6) or a hand lever, and that one or both bed sides (4) could be individually adjusted in height and locked into different positions, and that the baby crib (2) is equipped with a cradle lock, that could partly release the baby crib (2) from the tube stand (13) in such a way that the baby crib (2) could be used as a cradle, and that it is equipped with a blocking device that blocks the baby crib (2) from being used as a cradle, if the bed sides are not in their top position characterised in that the blocking device has the form of a cross-stroke (11) fixed to the tube stand (13), and that it is equipped with two longitudinal horizontal rollers (12) through which the bed side (4) could run up and down and locks the baby crib (2) from being rocked, if the bed side (4) is not in its top position.
